(19) United States
(12) Patent Application Publication
(10) Pub. No.: US 2007/0140468 A1
(43) Pub. Date: Jun. 21, 2007

(54) METHOD AND SYSTEM FOR SCHEDULING RESOURCES IN CUSTOMER CONTACT CENTERS

(75) Inventor: Rene Lebel, Candiac (CA)

Correspondence Address: DARBY & DARBY P.C., P. O. BOX 5257, NEW YORK, NY, 10150-5257, US

(73) Assignee: Spanlink Communications, Inc., Minneapolis, MN (US)

(21) Appl. No.: 11/556,273

(22) Filed: Nov. 3, 2006

Related U.S. Application Data
(60) Provisional application No. 60/733,207, filed on Nov. 4, 2005.

(51) Int. Cl. H04M 3/00; H04M 5/00

(52) U.S. Cl. 379/265.05

(57) ABSTRACT

There is provided a system and a method for simultaneously scheduling resources in customer contact centers based on the requirements of each skill. Indeed, the method simply relies on the analysis and duplication, without using complex simulations, of the routing of particular calls to each agent for each of his skills and for each sub-interval of a working day to then provide a simultaneous scheduling of resources based on the requirements of each skill calculated from previously captured customers' needs for each sub-interval of each selected working period.

### FIELD OF THE INVENTION

The present invention generally relates to methods and systems for scheduling resources in customer contact centers. It more particularly concerns a method and a system for generating schedules for call centers based on required skills.

### BACKGROUND OF THE INVENTION

Generally, simultaneous scheduling of resources, also named Workforce Synchronous Rationalization or WSR, based on the requirements of each skill, mainly applies to call centers, also named Customer Contact Centers. The main challenge of these service centers is to have the appropriate number of resources at all times, based on established service level objectives.

The arrival, in the last years, of skill-based routing of calls/contacts has made this challenge even more complex since an agent can now respond to many types of calls, as long as he has the required skills. Contact centers, which can have 200, 1000 or even 6000 agents, must have a workforce management software able to handle such a complex situation.

Most workforce management software, if not all of them, have been created before the arrival of skill-based call routing. Suppliers of these software have then “cobbled” solutions that were added to their rigid operating software in order to handle the skill-based call routing. Some have created incoming calls simulators based on generic or even rigid agent profiles. The main result of these methods is that most of the time, an agent is scheduled for one of his skill or another but not for all of them at the same time. These methods have thus lead to an inefficient planning of the resources.

To improve these methods, several dedicated computerized methods particularly intended to facilitate the workforce management in a call center have been provided. They generally provide satisfactory results but are however quite expensive and complex to implement since they often rely on complex simulations.

For example, known in the art, there are U.S. Pat. Nos. 6,856,680; 6,763,104; 6,044,355; 5,903,641 and 5,185,780, which all relate to systems and methods particularly devised for facilitating the workforce management in a call center.

Also of interest, there are U.S. Pat. Nos. 6,711,253 and 6,639,982 and also U.S. patent application published under No. 2003/0009520.

It would therefore be desirable to provide an improved method for efficiently scheduling resources in a customer call center that would not have to rely on complex simulations and that would be very easy to implement and manage while being affordable.

It would also be desirable to provide an improved method based on a new approach that could be naturally interlinked to some of the actual resource scheduling methods for providing in a simple manner a simultaneous scheduling of resources or a WSR based on the requirements of each skill.

### SUMMARY OF THE INVENTION

An object of the present invention is to provide a method and a system for scheduling resources in a customer contact center that satisfy the above-mentioned needs.

Accordingly, the present invention provides a method for simultaneously scheduling a plurality of agents in a customer contact center based on requirements of each of a plurality of skills. The method, which can also be named Workforce Synchronous Rationalization or WSR method, comprises the steps of:

a) capturing customer contact volumes handled by each of the plurality of agents having at least one of the skills to provide historical data of each agent based on the requirements of skills;

b) for each predetermined sub-interval of a selected daily working period, and for a predetermined number of the selected daily working period, calculating a specific mean skill coverage ratio for each agent from the historical data captured in step a); and

c) for each predetermined sub-interval of a selected daily working period to schedule, duplicating the specific mean skill coverage ratios of each agent to provide a schedule of the working period based on the requirements of skills calculated from previously captured customer needs for each sub-interval of each selected working period.

There is also provided a resource scheduling system for simultaneously scheduling a plurality of agents having at least one of a plurality of skills in a customer contact center based on requirements of each of the skills. The system has capturing means for capturing customer contact volumes handled by each agent to provide historical data of each agent based on the requirements of skills. The system also has a first database operatively connected to the capturing means for storing the historical data. The system is provided with calculating means operatively connected to the first database for calculating a specific mean skill coverage ratio for each agent for each predetermined sub-interval of a selected daily working period from the historical data of a predetermined number of the selected daily working period. The system also has a second database operatively connected to the calculating means for storing the specific mean skill coverage ratios. The system is also provided with duplicating means operatively connected to the second database for duplicating the specific mean skill coverage ratios of each agent for each sub-interval of a selected daily working period to schedule for providing a schedule of the working period based on the requirements of skills calculated from previously captured customer needs for each sub-interval of each selected working period.

### BRIEF DESCRIPTION OF THE DRAWINGS

These and other objects and advantages of the present invention will become apparent upon reading the detailed description and upon referring to the drawing in which:

FIG. 1 is a routing flowchart illustrating the scheduling method of the present invention.

While the invention will be described in conjunction with an example embodiment, it will be understood that it is not intended to limit the scope of the present invention to such an embodiment. On the contrary, it is intended to cover all alternatives, modifications and equivalents as may be included as defined by the appended claims.

### DESCRIPTION OF A PREFERRED EMBODIMENT

The present invention is directed to a method for simultaneously scheduling resources in customer contact centers based on the requirements of each skill. Indeed, the method, also named WSR method, relies on the analysis and duplication, in a simple and efficient way and without relying on complex simulations, of the routing of particular calls to each agent for each of his skills and for each sub-interval of a working day to then provide a simultaneous scheduling of resources based on the requirements of each skill. This method can advantageously be easily implemented and can also be easily integrated on an existing management system while being very affordable.

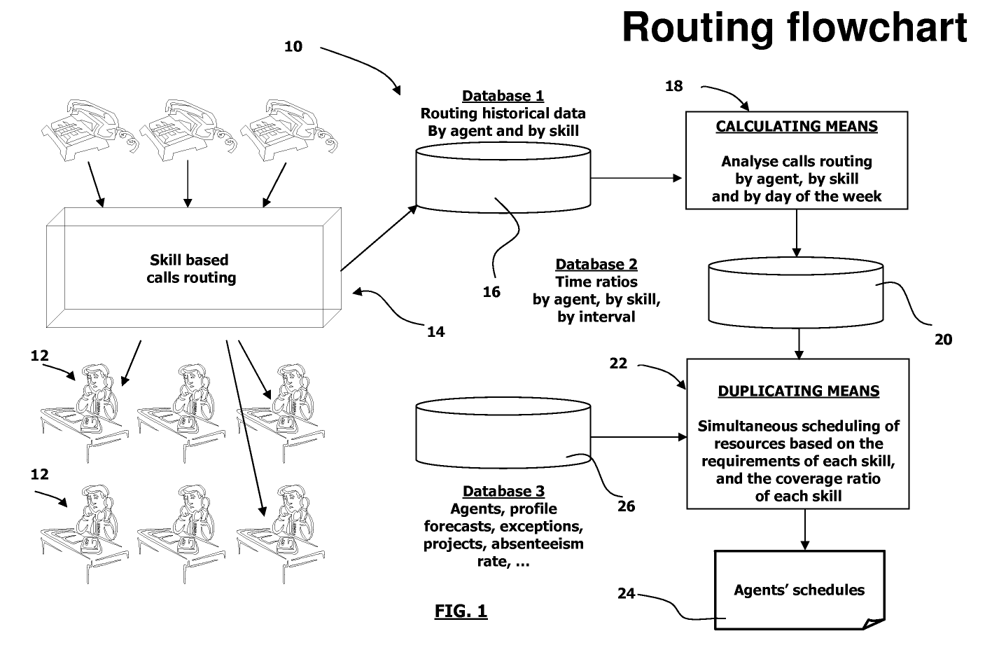

Referring to FIG. 1, there is shown a routing flowchart of the method for simultaneously scheduling a plurality of agents in a customer contact center based on requirements of each of a plurality of skills, according to the present invention. The method, which can also be named Workforce Synchronous Rationalization or WSR method, comprises the steps of:

a) capturing customer contact volumes handled by each of the plurality of agents having at least one of the skills to provide historical data of each agent based on the requirements of skills;

b) for each predetermined sub-interval of a selected daily working period, and for a predetermined number of the selected daily working period, calculating a specific mean skill coverage ratio for each agent from the historical data captured in step a); and

c) for each predetermined sub-interval of a selected daily working period to schedule, duplicating the specific mean skill coverage ratios of each agent to provide a schedule of the working period based on the requirements of skills calculated from previously captured customers' needs for each sub-interval of each selected working period.

It is worth mentioning that throughout the present description, by the expression “specific mean skill coverage ratio”, it is meant the ratio of time in each sub-interval that an agent has spent on his skill A, skill B . . . , these ratios of time being calculated on several identical sub-intervals to provide an average value thereof over a predetermined period. p Advantageously, the contact volumes are captured at the switch of the routing system.

In a preferred embodiment, the selected daily working period corresponds to a day of a week and the mean ratios are calculated on a period preferably ranging from a few weeks to a few months. Each predetermined sub-interval is preferably of 15 minutes but of course other sub-intervals could be considered according to a specific application. As it can be understood, the method can advantageously be implemented for each day of a week to provide a weekly schedule that simply and efficiently schedules an agent for several of his skills and that is adapted to the customers' needs. The method can advantageously schedule each day of the week independently, according to the historical data of each working day, or in a uniform manner, according to the specific needs of a particular application.

To better illustrate the method of the present invention, a non-limitative example will now be described. However, it is worth mentioning that this example is given as illustrative purposes only and should not be considered as limiting the scope of the present invention to such an embodiment. Thus, for example, the specific mean skill coverage ratio for a particular agent within the last three months could be the following for the 8h00 to 8h15 sub-interval of a selected working day:

Skill “A”: 75% of the contacts processed by the agent have been for this skill;

Skill “B”: 20% of the contacts processed by the agent have been for this skill; and

Skill “C”: 5% of the contacts processed by the agent have been for this skill.

Consequently, at schedule production time, the time spent by the agent that will be scheduled for this 8h00 to 8h15 sub-interval will be:

75% of his time on skill “A”;

20% of his time on skill “B”; and

5% of his time on skill “C”.

It can be seen from the foregoing that the steps of the method of the present invention can advantageously be very easily implemented, without relying on complex systems or simulations, as it is generally the case with the systems of the prior art.

Referring again to FIG. 1, according to another aspect of the present invention, there is provided a system for implementing the above-described method. More particularly, there is provided a resource scheduling system 10 for simultaneously scheduling a plurality of agents 12 having at least one of a plurality of skills in a customer contact center based on requirements of each of the skills, as described above. The system 10 has capturing means 14 for capturing customer contact volumes handled by each agent 12 to provide historical data of each agent based on the requirements of skills. The system 10 also has a first database 16 operatively connected to the capturing means 14 for storing the historical data. The system 10 is provided with calculating means 18 operatively connected to the first database 16 for calculating a specific mean skill coverage ratio for each agent for each predetermined sub-interval of a selected daily working period from the historical data of a predetermined number of the selected daily working period. In other words, the calculating means 18 allow to calculate each time ratio by agent by skill and by sub-interval, and more preferably by day of the week. The system 10 also has a second database 20 operatively connected to the calculating means 18 for storing the specific mean skill coverage ratios. The system 10 is also provided with duplicating means 22 operatively connected to the second database 20 for duplicating the specific mean skill coverage ratios of each agent for each sub-interval of a selected daily working period to schedule to provide a schedule of the working period 24 based on the requirements of skills calculated from previously captured customer needs for each sub-interval of each selected working period.

As mentioned above, the capturing means 14 may advantageously comprise a switch of a conventional routing system. Of course, other convenient capturing means could also be envisaged.

In a preferred embodiment of the present invention, each of the first and second databases 16, 20, the calculating means 18 and the duplicating means 22 are advantageously embedded in a computer.

In a further preferred embodiment, the system may also have a third database 26 for storing data about agents, profile forecasts, exceptions, projects, absenteeism rate and any other useful parameters that can advantageously be taken into consideration during the production of the schedule, according to a particular application.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A method for simultaneously scheduling a plurality of agents in a customer contact center based on requirements of each of a plurality of skills, said method comprising the steps of:
a) capturing customer contact volumes handled by each of the plurality of agents having at least one of said skills to provide historical data of each agent based on the requirements of skills;
b) for each predetermined sub-interval of a selected daily working period, and for a predetermined number of said selected daily working period, calculating a specific mean skill coverage ratio for each agent from the historical data captured in step a); and
c) for each predetermined sub-interval of a selected daily working period to schedule, duplicating the specific mean skill coverage ratios of each agent to provide a schedule of the working period based on the requirements of skills calculated from previously captured customers' needs for each sub-interval of each selected working period.

2. A resource scheduling system for simultaneously scheduling a plurality of agents having at least one of a plurality of skills in a customer contact center based on requirements of each of the skills, said system comprising:
capturing means for capturing customer contact volumes handled by each agent to provide historical data of each agent based on the requirements of skills;
a first database operatively connected to said capturing means for storing said historical data;
calculating means operatively connected to said first database for calculating a specific mean skill coverage ratio for each agent for each predetermined sub-interval of a selected daily working period from the historical data of a predetermined number of said selected daily working period;
a second database operatively connected to said calculating means for storing said specific mean skill coverage ratios; and
duplicating means operatively connected to said second database for duplicating the specific mean skill coverage ratios of each agent for each sub-interval of a selected daily working period to schedule to provide a schedule of the working period based on the requirements of skills calculated from previously captured customers' needs for each sub-interval of each selected working period.
